(19) United States
(12) Patent Application Publication
(10) Pub. No.: US 2004/0125131 A1
(43) Pub. Date: Jul. 1, 2004

(54) Apparatus and method for structured knowledge sharing and report generation

(76) Inventor: Carlton Thomas Phelps, Delmar, NY (US)

Correspondence Address: CARLTON T. PHELPS, 102 HUNTERSFIELD ROAD, DELMAR, NY, 12054, US

(21) Appl. No.: 10/248,208

(22) Filed: Dec. 27, 2002

(51) Int. Cl. G09G 5/00

(52) U.S. Cl. 345/738

(57) ABSTRACT

A system and method for capturing, storing, and retrieving technical information as a collection of related lexical concepts. The system comprises a context-sensitive user interface, a central server based lexicon, and a centralized or distributed storage system. The reporting interface presents the user with choices from the lexicon appropriate to the current context, simplifying the process and improving efficiency. The report hierarchy can be extended as needed to accommodate new classes of information. The system learns from user choices becoming more efficient over time.

### BACKGROUND OF THE INVENTION

There is an acute need in fields such as healthcare, intelligence and law enforcement for a means of capturing, storing and collating enormous quantities of information. A medical patient today may see several health care specialists at geographically diverse sites. Each physician needs immediate access to the others” observations and conclusions to know how to best serve the patient. Co-ordination of law enforcement and intelligence services is the only way to meet the challenge of ever more sophisticated criminal cartels and terrorist organizations.

Knowledge sharing in complex problem domains such as health care and law enforcement has heretofore been reduced to the production, preservation and transportation of textual documents. Prose is a flexible and compact means of information communication and storage. Prose dictation is broadly used to create and promulgate technical reports. Dictation is intuitive but requires a transcription step that delays information access. The resultant prose document cannot be easily codified or searched and prosaic reports lack precision and consistency. The very flexibility that makes prosaic reporting flexible also makes it nearly impossible to parse a report into discrete pieces of information that can be stored in a relational database and mined for desired information.

In the field of medicine, many investigators and standards bodies have proposed structured approaches to report generation. The American College of Radiology—National Electric Manufacturers Association (ACR-NEMA) Digital Imaging and Communication in Medicine (DICOM) standard defines a structured reporting standard for diagnostic image interpretation that describes a report as a collection of coded terms taken from lexical collections such as the American College of Pathology“s Systematized Nomenclature for Medicine (SNOMED). The Health Level Seven (HL7) standard is the most widely used protocol for communication of clinical information such as laboratory data and patient medical records. The upcoming Version 3 of the standard defines a Clinical Document Architecture based around the Extensible Markup Language (XML) and defining the semantics of report identification, security and the encoding of clinical data. The DICOM and HL7 structured reporting standards must interoperate since radiology procedure reports are often stored and accessed on Hospital Information Systems (HIS) which support HL7, yet the standards differ in several key respects. The HL7 standard is build around XML as a storage and messaging standard, and basically considers a structured report as a collection of named text blocks, e.g. “Observations”, “Conclusions”, etc. The DICOM standard leaves implementation to the developer and does not specify XML as a medium for storage and communication. DICOM describes a structured report as a collection of individual coded concepts and supports but discourages the use of text blocks.

Several attempts have been made to devise an efficient system for structured reporting in the field of Medical Imaging. Langlotz et al (2000) implemented a graphical user interface (GUI) based structured reporting software for evaluating chest roentgenograms. The interface presented the user with lists of diagnoses and standard modifier terms to record location, size, and confidence. They measured the average time it took to create a report on their structured reporting system and compared it to report creation times for standard dictation and voice recognition systems and found the structured reporting system to be significantly faster.

U.S. Pat. No. 6,366,683 to Langlotz describes this system as offering the user choices from several static “lexicons” such as a “Findings” lexicon and a “Modifier” lexicon. The context of the embodiment is to produce a report for a single type of image—a chest x-ray. The lexicons represented fixed lists that were organized by the software developer by associating each of them with a control such as a drop-down list control on the interface. In order to produce a report for a different type of examination, such as a bone x-ray, a different set of lists and a different user interface would have to be devised. A complete solution would require hundreds of interfaces, each tailored to an individual type of study. This solution could not be easily applied to other disciplines, as the interface was fairly specific to the medical reporting problem domain.

An unsolved dilemma evident in prior attempts at structured reporting has been the attempt to impose a single-object model on a diverse set of concepts. For example, a chest x-ray “finding” may be codified as having a single location attribute (or “modifier”) identifying the lobe or segment of the lung in which the finding is located and another attribute describing the location within that lobe based on three dimensional locators such as anterior-superior. On the other hand, identifying the location of a bone “finding” may require several modifiers including proximity to a joint, cortical (peripheral) verses medullar (central), and metaphyseal (end) verses diaphyseal (shaft). Thus in terms of object oriented design (OOD) the “class” used to describe a bone finding should have a different structure from the class describing a chest x-ray finding.

In U.S. Pat No. 5,715,449 Peters et al described a structured reporting system based on a “browser tree” of pages each representing a distinct medical terms or “node”. Each page offers a list of “sub-node” links. At the end of any browsing “path” is a set of Rich Text Format (RTF) phrases that can be assembled into a report.

This approach is enormously flexible because nodes can be added at will and each concept can be described independently. The limitations of this approach include memory inefficiency and long search-times that may be significant when the number of concepts climbs into the millions. There is also no way for the user to add nodes to the browser tree. Creating hundreds of thousands of HTML pages required to encompass enormous lexicons such as the medical lexicon would be a daunting task, and servicing this collection would be difficult.

The current invention improves on prior art in several ways: It is based on object-oriented (OO) organization of concepts in normalized hierarchies (contexts) of virtual classes. Each context represents a hierarchical collection of concepts. The root concept of each hierarchy represents a type of report component, i.e. Procedure, Observation, Conclusion, Plan, Attribute or Relationship. The concepts within each context are related to one another as parent to child wherein the child is a more specific example of its parent. The result is a deep hierarchy of classes that support object-oriented inheritance. This makes it easier to find a given concept and promotes economical sharing of attributes and associations between classes and their descendents. It also makes it practical for the system to “learn” from user choices. What makes the concept classes “virtual” is that the attributes that modify each class do not have to be persisted with the rest of the class description. In the preferred embodiment each class represents a row in a concept table comprising entries for a class universally unique identifier (UUID), a text representation of the concept, and the UUID of the parent concept of that class. The class“s attributes represent rows in a separate table indexed to the concept UUID. This results in a flexible and extensible set of class wrappers around the concepts with inform the structured reporting system. The class hierarchy is fully extensible by the user and is shared on a central server. This allows the class library to evolve with the help of expert users.

It will be difficult to entice expert users away from the familiar process of dictation and towards structured reporting. If the users are forced to search through a huge lexicon each time they pick a concept for inclusion in a report, they will become frustrated. The current invention keys off of concepts already included in the report, such as the type of procedure or event being reported, and constructs highly focused collections of related concepts, offering the user perhaps a dozen choices for each report category. Associations between concepts in different contexts inform the creation of these collections. The system learns from user choices by creating new associations, so the system evolves, becoming more efficient and easier to use over time.

The current invention describes methods that are applicable to knowledge collection and reporting in general, so they are applicable to any number of disciplines. The architecture is designed to be compatible with standard communication protocols including DICOM, HL7 version 3, HTML, HTTP, XML, and XSL. The result is a universal solution to the problem of knowledge collection, storage and reporting.

REFERENCES: Bell D, Pattison-Gordon E, Greenes R. Experiments in concept modeling for radiographic image reports. J Am Med Informatics Assoc 1994;1:249-262.

Campbell K, Wieckert K, Fagan L, Musen M. A computer-based tool for generation of progress notes. J Am Med Informatics Assoc 1993; Synposium Supplement:284-288.

Dockray K Solo practice management: Value of a computerized reporting system AJR American Journal of Roentgenology 1994;162:1439-1441.

Friedman C, Cimino J, Johnson S. A schema for representing medical language applied to clinical radiology. J Am Med Informatics Assoc 1994;1:233-248.

Hundt W, Adelhard K, Hundt C, Nissen-Meyer S, Kohz P, Fink U, Reiser M. A computer-based reporting system in radiology of the chest. European Radiology 1998;8:1002-1008.

Kahn C, Wang K, Bell D. Structured entry of radiology reports using world-wide web technology. Radiographics 1996;16:683-691.

Langlotz, C. P and Meininger L., Enhancing the Expressiveness and Usability of Structured Image Reporting Systems. AMIA Annual Symposium 2000.

Pendergrass H, Greenes R, Barnett G, Pouters I, Pappalardo A, Marble C. An on-line computer facility for systematized input of radiology reports. Radiology 1969;92:709-713.

Poon A, Fagan L. PEN-Ivory: The design and evaluation of a pen-based computer system for structured data entry. J Am Med Informatics Assoc 1994;(Symposium Supplement):447-451.

Puerta A, Eisenstein I. Towards a general computational framework for model-based interface development systems. In Proceedings of the International Conference on Intelligent User Interface Design. Los Angeles, Calif., 1999:(forthcoming).

### SUMMARY OF INVENTION

This invention comprises an object-oriented (OO) system for structured knowledge collection, storage, and reporting. Each of the concepts that inform a given discipline“s knowledge base or lexicon is encapsulated in a virtual class that comprises a collection of attributes that modify and identify that concept and a collection of associations with other concepts. The concept classes are organized into hierarchies of classes related to one another though normalized “is-a” or “part-of”, parent-child relationships. The class hierarchy is created by expert users and can be extended by any user as needed by adding a new concept to a context as the child of an existing concept. Concepts in different lexical contexts are cross-linked through multivariate relationships that imply an association between those concepts. The server identifies the “current context” of the report based on preliminary information such as the procedure being reported or based on the last concept chosen by the user. The server identifies associated concepts in other contexts and can then prioritize and present those concepts that are most appropriate to the current report context. The software learns by keeping track of new associations implied by user selections. The client-server architecture results in propagation of these new associations throughout the user base, so the process of report creation becomes more efficient over time. In the preferred embodiment described herein the user assembles a “report” and manages the knowledge base through a web browser via a dynamically generated Hypertext Markup Language (HTML) interface. The reports are stored and transmitted in Extensible Markup Language (XML) format. Those reports can be viewed or printed after conversion to HTML or formatted text using Extensible Style-sheet Language (XSL) documents. The information that comprises a report represents collections of coded concepts and attributes that can be indexed and stored in a relational database for easy query and retrieval of the raw information.

### BRIEF DESCRIPTION OF DRAWINGS

FIG. 1 is a block diagram of the system architecture of the preferred embodiment.

FIG. 2 is the Report Constructor page of the dynamically created browser interface.

FIG. 3 is an example of the hierarchical structure of the concept class library.

FIG. 4 is an example of a mutivariate relationship between four concepts in four contexts.

### DETAILED DESCRIPTION

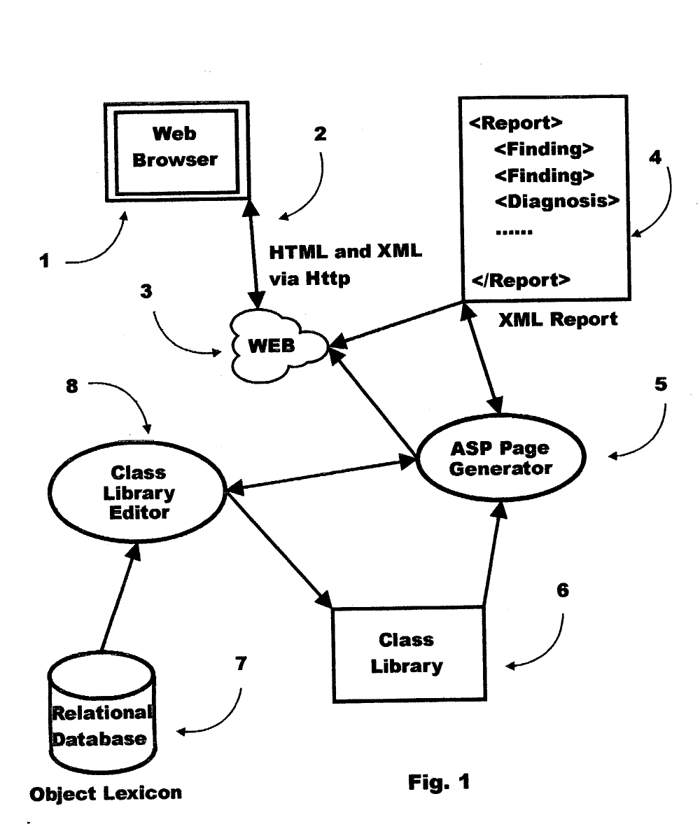

FIG. 1 illustrates a typical architecture for report generation and storage. A web service running on one or more web servers 1 responds to a page request from a web browser 2 by generating an Active Server Page (ASP) and sending it to the Web Browser via Hypertext Transfer Protocol (HTTP or HTTPS) 3 over the World Wide Web 4. The ASP Page Generator 5 presents the user with an active Hypertext Markup Language (HTML) graphical user interface that permits the user to build an XML Report 6 from objects chosen from context-sensitive lists generated by the Concept Class Manger 7. If the user needs a concept that is not represented in the Object Lexicon 8 then the ASP Page Generator 5 presents the user with a browser based dialog that allows the user to add a new concept. The Concept Class Manager is responsible for determining the current context, generating context-sensitive lists of concepts for user selection based on associations in the Object Lexicon 8, and creating new associations based on user selections.

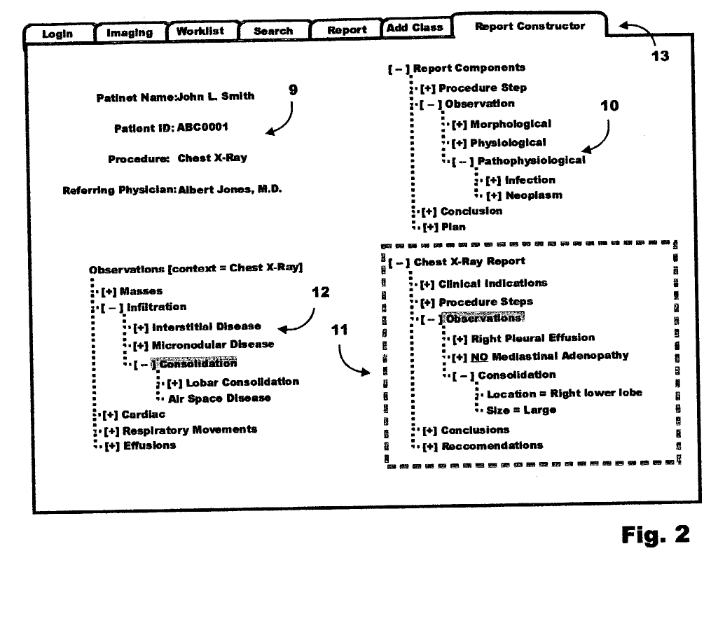

FIG. 2 depicts the basic user interface layout for the Report Constructor Page that will appear in the user“s browser window. After the user logs in, the information system loads a “subject“s” demographic data into the interface 9 and creates an empty report. The Page Generator then loads the entire lexicon into a hierarchical navigation Tree View control, the Class Hierarchy Navigator 10. The user can navigate through this hierarchical list to any concept in the lexicon and can add a concept object to the report by dragging the concept to the appropriate section of the report in the Report Navigator 11. A more manageable context-based selection of concepts is presented in the Contextual Concept Navigator 12. This represents those concepts from the lexicon that are associated with the current context, e.g. with the type of procedure being reported or with the concept last added to the report. For example if the user adds “Bacterial Pneumonia” to the “Conclusions” collection of a chest X-Ray report, the Contextual Concept Navigator will offer observations that are associated with pneumonia in the context of a Chest X-Ray, such as “Lung densities”. The user can then edit the attributes of the concept by right clicking on the attribute to be edited in the Report Navigator 11. A hierarchical list of possible attributes will appear in the Contextual Concept Navigator 12. The user can identify typed relationships such as “caused-by” or “implies” between the concept objects that comprise a report by dragging one concept over another. A dialog box will pop up offering choices for the type of relationship and a list of relationship that the user has already created for this report. By choosing an existing relationship the user can establish multivariate associations such as the “Observations” that led the user to a given “Conclusion” or a set of “Conclusions” any one of which might explain a set of “Observations”. This type of relationship is only true within the context of the current report and is therefore considered “local” to the report. It is not added to the master table of associations.

Other pages can be accessed via the page navigation bar 13. The View Report page displays a fully rendered HTML version of the XML report. This is the version of the report that is easiest to read.

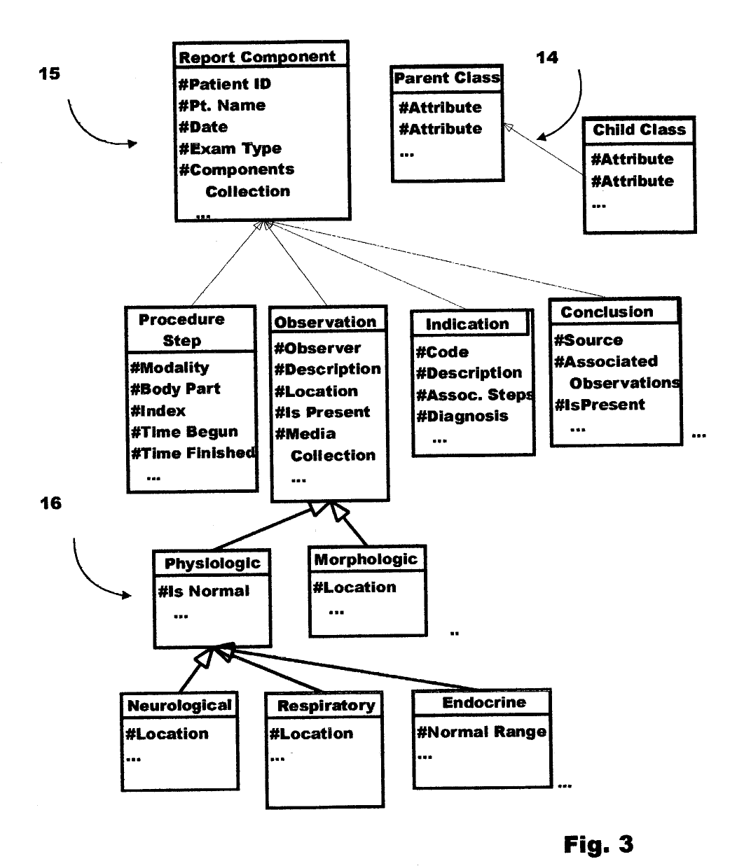

FIG. 3 depicts a portion of a typical Class Library. Boxes represent classes with the class name at the top of the box and the attributes below 15. The connectors represent parent-child relationships with the arrowheads pointing at the parents. Each class inherits the attributes of the parent class. Thus the Physiologic Observation class 16 shares the attributes “Location”, “Is Present, etc. with the Observation base class. In the preferred implementation each concept class represents a row in a “Concepts” relational database table, while attributes are in a separate “Attributes” table, indexed to the unique identifier of the concept. In other embodiments concepts could also be persisted as binary objects or as XML types.

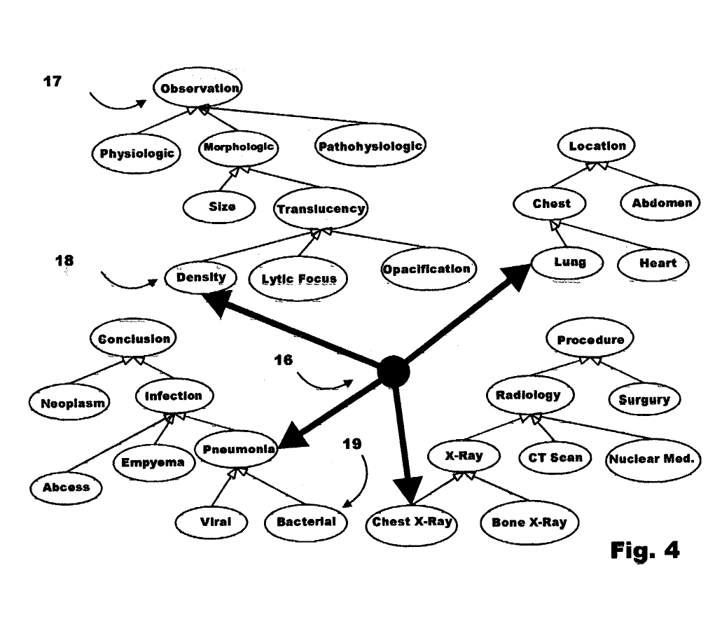

FIG. 4 illustrates a multivariate association between four concepts, each in a different “context”. A context represents a normalized collection of concepts related to one another in an is-a or part-of hierarchy. Because the contexts are normalized, a concept can appear only once in each context. If a given term is repeated in another context it is considered to represent a different concept. Thus the concept “cat” would represent one concept in the context of “house pets” and another in the context “predator”. A given concept implies a context, so given a concept it is possible to find its parent and child concepts. FIG. 4 represents a multivariate lexical associations 6 between the concepts “Density” 18, “Pneumonia”, “Chest X-Ray” and “Lung” in the contexts “Observation”, “Conclusion”, “Procedure” and “Location” respectively. The fact that these contexts are strict “is-a” hierarchies means that these relationships are inherited Bacterial Pneumonia 19 also participates in the relationship, as would any of its children. The meaning of the relationship is that these concepts tend to occur together. Simpler relationships, such as a binary relationships, can be represented by a four way relationship wherein two of the concepts represent root concepts in their respective contexts. Thus in FIG. 4 an association between the concepts “Density”, “Pneumonia”, “Location” and “Procedure” would imply that the concepts “Density” and “Pneumonia” tend to occur together regardless of the type of exam or body part under discussion, since this association would be inherited by all of the descendants of “Location” and “Procedure”. Usually the Procedure type is known before the user begins preparing the report. Thus in the context of a blank Chest X-Ray report the interface would prioritize “Density” and its children as potential observations and “Pneumonia” and its children as potential conclusions in the Contextual Concept Navigator 12. The user could still pick an “unfiltered” concept from the Class Hierarchy Navigator 10, and in that case a new association would be created and stored allowing the server to prioritize that choice next time. Each associations has a “strength” attribute which can be adjusted depending on the number of times a user includes a concept in a given context. This process results in an interface with becomes more intelligent with use.

Users can add concepts to the hierarchies “on-the-fly”. The Class Library is shared throughout the enterprise so all users can immediately share these new concepts.

1. An object oriented method for capturing, storing, and retrieving technical information as a collection of related lexical concepts via an extensible, context-sensitive, browser-based graphical user interface comprising:
an extensible central server-based relational database containing a lexicon of concepts;
a method for organizing concepts into a lexicon of normalized hierarchical contexts;
allowing users to assemble concepts from a hierarchy of concept classes into a structured report;
a method for linking concepts in different contexts in the lexicon with multivariate associations;
using those associations to present context-appropriate collections of concepts to the user for selection in the report;
learning by automatically detecting and storing new associations implied by user choices;
using new associations to inform the creation of context-appropriate collections for all users;
allowing the user to enter values for class attributes representing concept modifiers;
allowing the user to establish typed relationship between the concepts that comprise a report;
producing an XML based report;
using XSL style sheets to create easily readable reports in text or HTML format;
storing the report in a file system;
storing the components of the report in a relational database.

2. The method of claim 1 [claim Reference] wherein the graphical user interface is not browser based.

3. The method of claim 1 [claim Reference] wherein the lexicon and associations are stored in an object database.

4. The method of claim 1 [claim Reference] wherein the lexicon and associations are stored as binary objects.

5. The method of claim 1 [claim Reference] wherein the lexicon and associations are stored in XML format.

6. The method of claim 1 [claim Reference] wherein all of the components reside on the same computer.

7. The method of claim 1 wherein the Class Library or a copy of it resides on the client machine.
